(19) United States
(12) Patent Application Publication
(10) Pub. No.: US 2014/0033072 A1
(43) Pub. Date: Jan. 30, 2014

(54) Method And Apparatus For Notifying Friend

(71) Applicant: TENCENT TECHNOLOGY (SHENZHEN) COMPANY LIMITED, Shenzhen City (CN)

(72) Inventors: Zhihao ZHENG, Shenzhen City (CN); Zhu LIANG, Shenzhen City (CN); Yingbin LI, Shenzhen City (CN)

(73) Assignee: TENCENT TECHNOLOGY (SHENZHEN) COMPANY LIMITED, Shenzhen City (CN)

(21) Appl. No.: 14/041,918

(22) Filed: Sep. 30, 2013

Related U.S. Application Data
(63) Continuation of application No. PCT/CN2012/071573, filed on Feb. 24, 2012.

(30) Foreign Application Priority Data
Apr. 15, 2011 (CN) 201110094851.3

(51) Int. Cl. H04L 12/58

(52) U.S. Cl. CPC H04L 51/32
USPC 715/752

(57) ABSTRACT

A method for notifying a friend includes configuring a friend notifying input box in a text editing interface; initiating a friend association based on a keyword input by a user and a friend list of the user, according to the keyword input in the friend notifying input box by the user; determining at least one friend to be selected from the friend list of the user according to the keyword; determining at least one friend selected by the user from the at least one friend as at least one target friend; sending a friend notification to the at least one target friend after the user finishes editing a text and posts the text. An apparatus for notifying a friend is provided.

### CROSS-REFERENCE TO RELATED APPLICATIONS

This application is a continuation of International Application No. PCT/CN2012/071573, filed on Feb. 24, 2012. This application claims the benefit and priority of Chinese Patent Application No. 201110094851.3, filed on Apr. 15, 2011. The entire disclosures of each of the above applications are incorporated herein by reference.

### FIELD

The present disclosure relates to network community technologies and to a method and apparatus for notifying a friend.

### BACKGROUND

This section provides background information related to the present disclosure which is not necessarily prior art.

Currently, in a blog, a forum, or a community on the Internet, users may post an article, e.g. a log, a state, or a commentary. The article may include a name of a friend of the user, and the user may hope to notify the friend mentioned in the article once the article is posted. However, if the user wants to notify the friend of the article posted in the blog, the forum, or the community, the user may send an e-mail, make a telephone call, send a short message, or leave a message on a space, a blog, or a message board of the friend, so as to notify the friend of the article where the friend is mentioned.

Regardless of the mode used to notify the friend, the user needs to edit a notification after posting the article. When multiple friends are mentioned in the article and need to be notified, multiple notifications need to be edited repeatedly, which is too tedius for the user.

### SUMMARY

This section provides a general summary of the disclosure, and is not a comprehensive disclosure of its full scope or all of its features.

Various embodiments disclose a method and apparatus for notifying a friend, so as to notify a friend mentioned in text edited by a user of a forum, a blog, a community, etc.

A method for notifying a friend includes:

configuring a friend notifying input box in a text editing interface;

initiating a friend association based on a keyword input by a user and a friend list of the user, according the keyword input in the friend notifying input box by the user;

determining at least one friend to be selected from the friend list of the user according to the keyword;

determining at least one friend selected by the user from the at least one friend as at least one target friend; and

sending a friend notification to the at least one target friend after the user finishes editing a text and posts the text.

A method for notifying a friend includes:

initiating a friend association based on a key word input by a user and a friend list of the user, according to a preset friend notifying identifying symbol input by the user in a text editing box;

determining at least one friend to be selected from the friend list of the user according to the keyword;

determining at least one friend selected by the user from the at least one friend as at least one target friend;

sending a friend notification to the at least one target friend after the user finishes editing a text and posts the text.

A method for notifying a friend includes:

adding a start button in a text editing interface for initiate selection of a target friend;

popping up a friend selector when a user presses the start button; the friend selector comprising all friends of the user;

inserting a name of at least one friend selected by the user form the friend selector into a text editing box;

taking the at least one friend selected by the user from the friend selector as at least one target friend; and

sending a friend notification to the at least one target friend after the user finishes editing a text and posts the text.

An apparatus for notifying a friend includes:

a processor for executing instructions stored in a memory, the instructions comprise:

an inputting instruction, to configure a friend notifying input box in a text editing interface, according a keyword input in the friend notifying input box by a user, initiate a friend association based on the keyword input by the user and a friend list of the user;

a matching instruction, to determine friends to be selected from the friend list of the user according to the keyword; and

a notifying instruction, to determine at least one friend selected by the user from the friends to be selected as at least one target friend, and send a friend notification to the target friend after the user finishes editing a text and posts the text.

An apparatus for notifying a friend includes:

a processor for executing instructions stored in a memory, the instructions comprise:

an associating instruction, to initiate a matching instruction to perform a friend association based on a key word input by a user and a friend list of the user, according to a preset friend notifying identifying symbol input by the user in a text editing box;

the matching instruction, to determine friends to be selected from the friend list of the user according to the keyword; and

a notifying instruction, to determine at least one friend selected by the user from the friends to be selected as at least one target friend, and send a friend notification to the target friend after the user finishes editing a text and posts the text.

An apparatus for notifying a friend includes:

a processor for executing instructions stored in a memory, the instructions comprise:

a selector instruction, to add a start button in a text editing interface for initiating selection of a target friend; pop up a friend selector when a user presses the start button; the friend selector comprising all friends of the user;
an inserting instruction, to insert a name of a friend selected by the user from the friend selector into a text editing box; and a notifying instruction, to take at least one friend selected by the user from the friend selector as at least one target friend; and send a friend notification to the at least one target friend after the user finishes editing a text and posts the text.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for notifying a friend according to various embodiments.

FIG. 2 is a schematic diagram illustrating a structure of an apparatus for notifying a friend according to various embodiments.

FIG. 3 is a schematic diagram illustrating a structure of an associating module according to various embodiments.

FIG. 4 is a schematic diagram illustrating a structure of a matching module according to various embodiments.

FIG. 5 is a schematic diagram illustrating a structure of a notifying module according to various embodiments.

FIG. 6 is a schematic diagram illustrating an effect of notifying a friend according to various embodiments.

FIG. 7 is a schematic diagram illustrating a structure of an apparatus for notifying a friend according to various embodiments.

FIG. 8 is a schematic diagram illustrating a structure of an apparatus for notifying a friend according to various embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to clarify the object, technical solution, and merits, the present disclosure will be illustrated in detail hereinafter with reference to the accompanying drawings and specific examples.

In various embodiments, the friend notifying input box is configured in the text editing interface; the friend association based on a keyword input by a user and a friend list of the user is initiated according the keyword input in the friend notifying input box by the user. At least one friend to be selected is determined from the friend list of the user according to the keyword. At least one friend selected by the user from the at least one friend is determined as at least one target friend. The friend notification is automatically sent to the at least one target friend after the user finishes editing a text and posts the text. In this way, the user does not need to edit the notification for the friend mentioned in the text respectively, and the operations of the user are simplified.

FIG. 1 is a flowchart illustrating a method for notifying a friend according to various embodiments, and the method includes the following.

In block 101, a friend notifying input box is configured in a text editing interface; according a keyword input in the friend notifying input box by a user, a friend association based on the keyword input by the user and a friend list of the user is initiated.

The friend notifying input box is configured in the text editing interface used for posting an article. The text editing interface may be a text editing interface of a blog, a message board, a photo album, a diary, a commentary, etc. When the user inputs the keyword in the friend notifying input box, the friend association is initiated.

In block 102, friends to be selected are determined from the friend list of the user according to the keyword.

In this block, when the keyword matches the name of the friend, e.g. when the name of the friend includes the keyword, the friend is determined as the friend to be selected. The friends to be selected are displayed as a list at a current cursor position or at any location in the interface, which is not limited in the present disclosure.

According to various embodiments, in blocks 101 to 102, after the user inputs the keyword in the friend notifying input box, the friends to be selected are displayed below the friend notifying input box automatically, and the top 5 matched friends to be selected are displayed. In the list of friends to be selected, the user may press ↑↓ keys on the keyboard to select the friend to be selected, press ESC key to cancel the selection, directly press Enter key to select the first friend to be selected, or press ↓ key to check next 5 friends to be selected. In addition, the friend association may be initiated by inputting a symbol “@” at any location of the friend notifying input box. The friend selected by the user may be displayed with different background. Information of the friend to be selected displayed in the list may include: avatar+notes+nickname+QQ number. The user may press the Backspace key to backspace and change a matching result in real time.

In block 103, at least one friend selected by the user from the friends to be selected is determined as at least one target friend.

In this block, a label indicating a friend is configured for the friend selected by the user from the list of the friends to be selected, and the label includes contact information of the friend. The friend having the label is determined as the target friend.

After the user selects the friend, a nickname of the friend is displayed in highlight in the friend notifying input box, so as to indicate that the friend has the label and is the target friend. The user may press the Backspace key to cancel the whole nickname of the friend, rather than to cancel the last character of the nickname. Further, the user may select multiple friends continuously.

In block 104, a friend notification is sent to the target friend after the user finishes editing a text and posts the text.

In this block, the friend notification is sent to the friend having the label according to the contact information in the label. The contact information includes at least one of a friend identifying number, a nickname of the friend and a registered name of the friend. The friend identifying number may be QQ number.

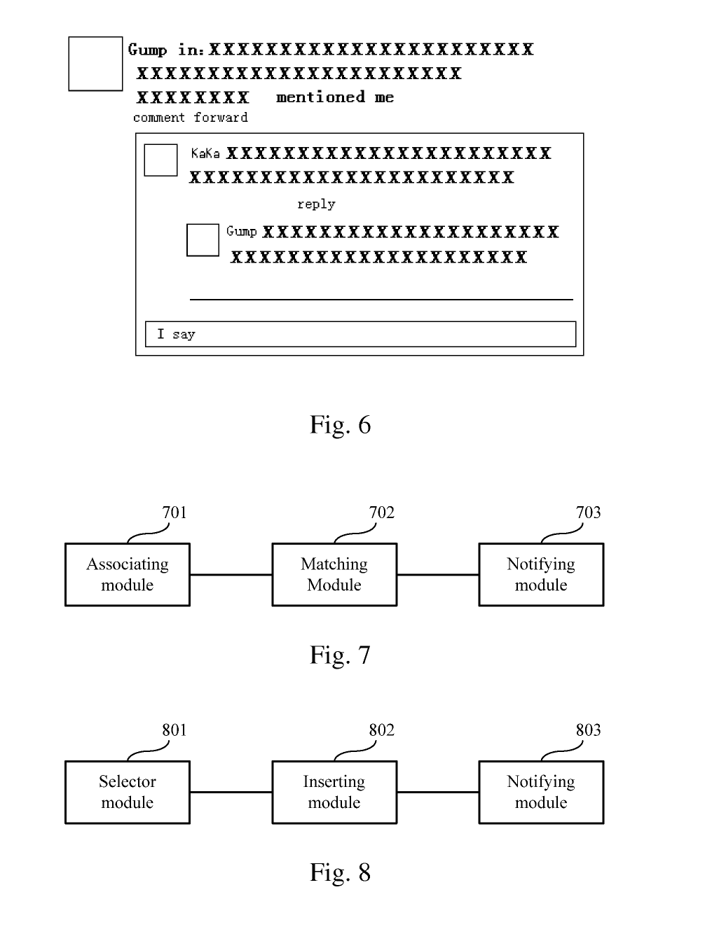

When sending the friend notification, the text posted by the user may be sent to a personal dynamic area of the friend having the label, and prompt information may be displayed to indicate that the friend is mentioned in the text posted by the user, as shown in FIG. 6, “mentioned me” is added after the text posted by the user. In addition, an input box is provided, the user and the friend may perform further interactions in the friend notification, such as the friend may comment on the text or reply to the user.

Various embodiments may be applied for all applications having an input box, such as applications based on community relation chain for commenting or replying in a log, a message board, a photo album, etc.

According to the above mentioned embodiment, the user may input the keyword in the friend notifying input box and send the friend notification to the selected friend, and the user does not need to edit a notification and send the notification for each friend, thereby simplifying the operations of the user. In the above mentioned embodiment, the user needs to input the keyword to select the friend to be notified besides editing the text, and a preset friend notifying identifying symbol is used to initiate the selection of the target friend. When the user inputs the name of the friend during the procedure of editing the text, the target friend is determined, and thus the friend notifying input box is not needed to determine the target friend, thereby further simplifying the operations of the user.

According to the embodiment, the friend notifying input box is not needed, and the friend association based on the key word input by the user and the friend list of the user is initiated according to the friend notifying identifying symbol input by the user in a text editing box (e.g. a text editing box of a blog, a message board, a photo album, a diary, a commentary, etc.). When the friend notifying identifying symbol is input in the text editing box, contents of the text editing box is checked, a last friend notifying identifying symbol in front of a current cursor is determined, text between the friend notifying identifying symbol and the current cursor is extracted and taken as the keyword to be associated, that is, the friend notifying identifying symbol is not included in keyword to be associated.

For example, a symbol @ may be taken as the friend notifying identifying symbol. After the user inputs the symbol @, the user is prompted to input a nickname, a number or remarks of a friend below the text editing box, so as to initiate the friend association.

After the friend association is initiated, subsequent operations are the same as when the friend notifying input box is used, which will not be described herein.

According to this embodiment, the user does not need to determine the target friend via the friend notifying input box, thereby simplifying the operations of the user, and further eliminating inconsistency between the target friend selected in the friend notifying input box and the friend mentioned in the text which is inadvertently caused by the user.

In addition, in the above embodiment, the user needs to input the symbol @ to initiate the friend association. According to another embodiment, the user may implement the function of notifying the friend using only mouse operations.

According to the embodiment, a start button, e.g. “@” button is added in the text editing interface for initial selection of the target friend. When the user presses the start button, a friend selector pops up. All friends of the user are included in the friend selector and the friend association is not performed. After the user selects a friend to be mentioned, the name of the selected friend is inserted into the text editing box in a mode different from normal text, e.g. adding the symbol @ in front of the name of the friend. The friend having the symbol @ in the text editing box is selected as the target friend. Other operations of sending the friend notification are the same as the previously described embodiments and will not be described herein.

In specific applications, the above three mentioned embodiments may be implemented at the same time, i.e. three methods for notifying the friend is provided, and the user may select one of the methods in the interface according to preferences.

In addition, an apparatus for notifying a friend is provided to implement the above methods

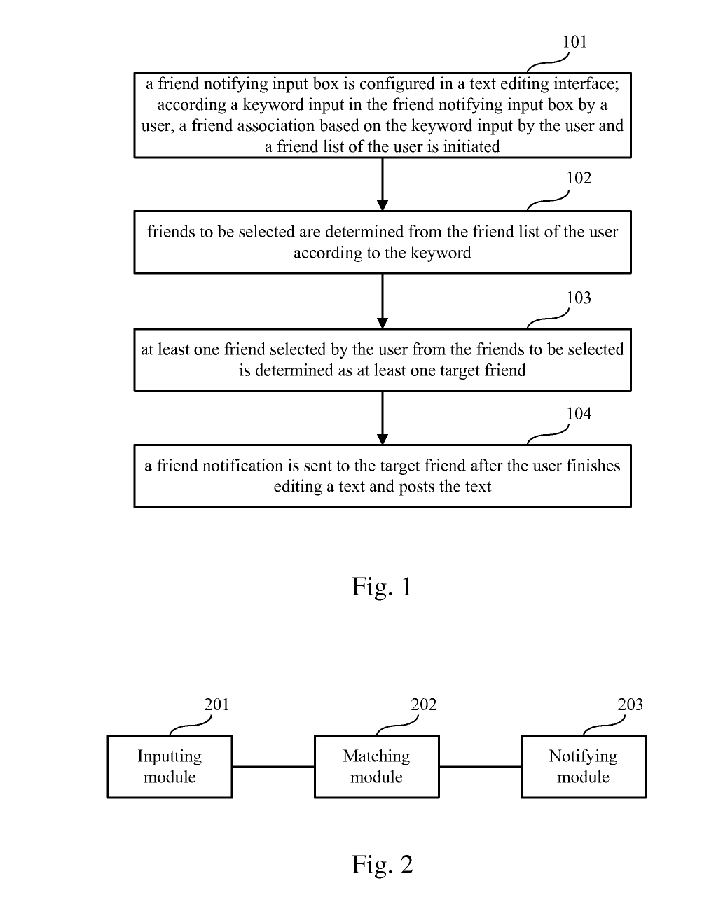

FIG. 2 is a schematic diagram illustrating a structure of an apparatus for notifying a friend according to various embodiments. As shown in FIG. 2, the apparatus includes an inputting module 201, a determining module 202 and a notifying module 203.

The inputting module 201 configures a friend notifying input box in a text editing interface; according to a keyword input in the friend notifying input box by a user, initiates a friend association based on the keyword input by the user and a friend list of the user.

The matching module 202 determines friends to be selected from the friend list of the user according to the keyword.

The notifying module 203 determines at least one friend selected by the user from the friends to be selected as at least one target friend, and send a friend notification to the target friend after the user finishes editing a text and posts the text.

FIG. 7 is a schematic diagram illustrating a structure of an apparatus for notifying a friend according to various embodiments. As shown in FIG. 7, the apparatus includes an associating module 701, a determining module 702 and a notifying module 703.

The associating module 701 initiates a friend association based on a key word input by a user and a friend list of the user, according to a friend notifying identifying symbol input by the user in a text editing box.

The matching module 702 determines friends to be selected from the friend list of the user according to the keyword.

The notifying module 703 determines at least one friend selected by the user from the friends to be selected as at least one target friend, and sends a friend notification to the target friend after the user finishes editing a text and posts the text.

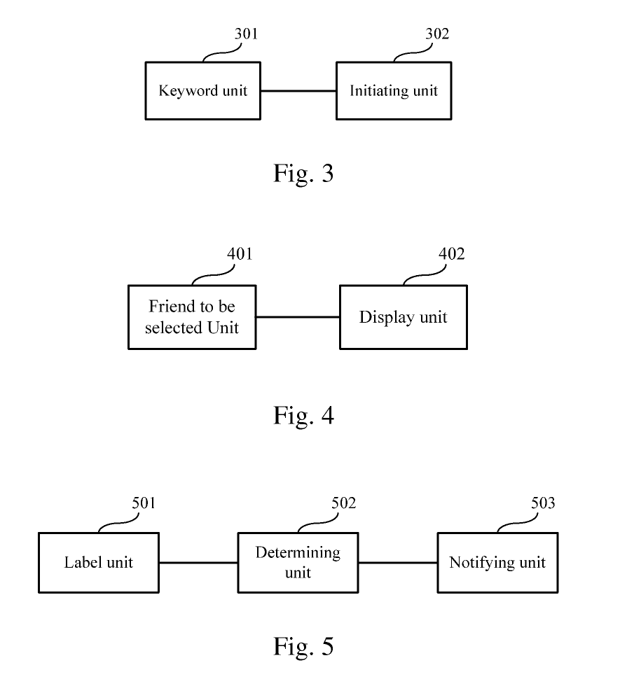

The structure of the associating module 701 is shown in FIG. 3. The associating module 701 includes a keyword unit 301 and an initiating unit 302.

The keyword unit 301 checks contents of the text editing box; determines a last friend notifying identifying symbol in front of a current cursor; extracts text between the friend notifying identifying symbol and the current cursor except the friend notifying identifying symbol; and takes the text extracted as the keyword.

The initiating unit 302 initiates the matching module 202 to perform the friend association based on the keyword and the friend list.

The structure of determining module 702 is shown in FIG. 4. The determining module 702 includes a friend to be selected unit 401 and a display unit 402.

The friend to be selected unit 401 determines a friend as the friend to be selected when a name of the friend comprises the keyword.

The display unit 402 displays the friends to be selected as a list at a current cursor position.

The structure of the notifying module is shown in FIG. 5. The notifying module includes a label unit 501, a determining unit 502 and a notifying unit 503.

The label unit 501 configures a label indicating a friend for the friend selected by the user from the list of the friends to be selected, and the label includes contact information of the friend.

The determining unit 502 determines the friend having the label as the target friend.

The notifying unit 503 sends the friend notification to the friend having the label according to the contact information in the label.

FIG. 8 is a schematic diagram illustrating a structure of an apparatus for notifying a friend according to various embodiments. The apparatus includes a selector module 801, an inserting module 802, and a notifying module 803.

The selector module 801 adds a start button in a text editing interface for initial selection of a target friend; pops up a friend selector when a user presses the start button; the friend selector comprising all friends of the user.

The inserting module 802 inserts a name of a friend selected by the user from the friend selector into a text editing box in a mode different from normal text, e.g. adding a symbol @ in front of the name of the friend.

The notifying module 803 takes at least one friend selected by the user from the friend selector as at least one target friend; and sends a friend notification to the at least one target friend after the user finishes editing a text and posts the text.

The structure of the notifying module 803 is similar to that shown in FIG. 5, the difference includes that the label is configured for the friend selected by the user from the friend selector when the label unit configures the label.

In the above three embodiments, the determining modules and the notifying modules have the same functions. The above three embodiments may be implemented at the same time, i.e. corresponding module may be included.

According to the method and apparatus provided by the above mentioned embodiments, the target friend is selected according to the friend notifying input box or the friend notifying identifying symbol. After posting the article, the user does not need to edit and send the notification, thereby simplifying the operations of the user.

The methods and modules described herein may be implemented by hardware, machine-readable instructions or a combination of hardware and machine-readable instructions. Machine-readable instructions used in the embodiments disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers, and so on.

A machine-readable storage medium is also provided, which stores instructions to cause a machine to execute a method as described herein. Specifically, a system or apparatus having a storage medium that stores machine-readable program codes for implementing functions of any of the above embodiments and that may make the system or the apparatus (or CPU or MPU) read and execute the program codes stored in the storage medium.

In this situation, the program codes read from the storage medium may implement any one of the above embodiments. Thus, the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM, and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above embodiments.

In addition, the program codes implemented from a storage medium are written in a storage in an extension board inserted in the computer or in a storage in an extension unit connected to the computer. In this embodiment, a CPU in the extension board or the extension unit executes at least part of the operations according to the instructions based on the program codes to realize a technical scheme of any of the above embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for notifying a friend, comprising:
configuring a friend notifying input box in a text editing interface;
initiating a friend association based on a keyword input by a user and a friend list of the user, according the keyword input in the friend notifying input box by the user;
determining at least one friend to be selected from the friend list of the user according to the keyword;
determining at least one friend selected by the user from the at least one friend as at least one target friend; and
sending a friend notification to the at least one target friend after the user finishes editing a text and posts the text.

2. The method of claim 1, wherein determining at least one friend to be selected from the friend list of the user according to the keyword comprises:
determining a friend as the friend to be selected when a name of the friend comprises the keyword; displaying the at least one friend to be selected as a list at a current cursor position.

3. The method of claim 1, wherein determining at least one friend selected by the user from the at least one friend as at least one target friend comprises:
configuring a label indicating a friend for the friend selected by the user from the at least one friend to be selected, and the label comprising contact information of the friend; determining the friend having the label as the target friend.

4. The method of claim 1, wherein sending the friend notification to the at least one target friend comprises:
sending the text posted by the user to a personal dynamic area of the friend having the label according to the contact information comprised in the label, and sending prompt information to indicate that the friend is mentioned in the text posted by the user.

5. A method for notifying a friend, comprising:
initiating a friend association based on a key word input by a user and a friend list of the user, according to a preset friend notifying identifying symbol input by the user in a text editing box;
determining at least one friend to be selected from the friend list of the user according to the keyword;
determining at least one friend selected by the user from the at least one friend as at least one target friend;
sending a friend notification to the at least one target friend after the user finishes editing a text and posts the text.

6. The method of claim 5, wherein initiating the friend association based on the key word input by the user and the friend list of the user, according to a preset friend notifying identifying symbol input by the user in a text editing box comprises:
checking contents of the text editing box, determining a last friend notifying identifying symbol in front of a current cursor, extracting text between the friend notifying identifying symbol and the current cursor except the friend notifying identifying symbol; and taking the text extracted as the keyword.

7. The method of claim 5, wherein determining at least one friend to be selected from the friend list of the user according to the keyword comprises:
determining a friend as the friend to be selected when a name of the friend comprises the keyword; displaying the at least one friend to be selected as a list at a current cursor position.

8. The method of claim 5, wherein determining at least one friend selected by the user from the at least one friend as at least one target friend comprises:
configuring a label indicating a friend for the friend selected by the user from the at least one friend to be selected, and the label comprising contact information of the friend; determining the friend having the label as the target friend.

9. The method of claim 5, wherein sending the friend notification to the at least one target friend comprises:
sending the text posted by the user to a personal dynamic area of the friend having the label according to the contact information comprised in the label, and sending prompt information to indicate that the friend is mentioned in the text posted by the user.

10. The method of claim 9, wherein the contact information comprises at least one of a friend number, a nickname of the friend and a register name of the friend.

11. A method for notifying a friend, comprising:
adding a start button in a text editing interface for initiate selection of a target friend;
popping up a friend selector when a user presses the start button; the friend selector comprising all friends of the user;
inserting a name of at least one friend selected by the user form the friend selector into a text editing box;
taking the at least one friend selected by the user from the friend selector as at least one target friend; and
sending a friend notification to the at least one target friend after the user finishes editing a text and posts the text.

12. The method of claim 11, wherein inserting the name of at least one friend selected by the user form the friend selector into the text editing box comprises:
inserting the name of the at least one friend selected by the user from the friend selector into the text editing box by adding a symbol @ in front of the name of the friend.

13. The method of claim 11, wherein taking the at least one friend selected by the user from the friend selector as at least one target friend comprises:
configuring a label indicating a friend for the friend selected by the user from the friend selector, and the label comprising contact information of the friend; determining the friend having the label as the target friend.

14. The method of claim 11, wherein sending the friend notification to the at least one target friend comprises:
sending the text posted by the user to a personal dynamic area of the friend having the label according to the contact information comprised in the label, and sending prompt information to indicate that the friend is mentioned in the text posted by the user.

15. An apparatus for notifying a friend, comprising:
a processor for executing instructions stored in a memory, the instructions comprise:
an inputting instruction, to configure a friend notifying input box in a text editing interface, according a keyword input in the friend notifying input box by a user, initiate a friend association based on the keyword input by the user and a friend list of the user;
a matching instruction, to determine friends to be selected from the friend list of the user according to the keyword; and
a notifying instruction, to determine at least one friend selected by the user from the friends to be selected as at least one target friend, and send a friend notification to the target friend after the user finishes editing a text and posts the text.

16. The apparatus of claim 15, wherein the matching instruction comprises:
a friend to be selected instruction, to determine a friend as the friend to be selected when a name of the friend comprises the keyword; and
a display instruction, to display the friends to be selected as a list at a current cursor position.

17. The apparatus of claim 15, wherein the notifying instruction comprising:
a label instruction, to configure a label indicating a friend for the friend selected by the user from the list of the friends to be selected, and the label comprising contact information of the friend;
a determining instruction, to determine the friend having the label as the target friend; and
a notifying instruction, to send the friend notification to the friend having the label according to the contact information in the label.

18. An apparatus for notifying a friend, comprising:
a processor for executing instructions stored in a memory, the instructions comprise:
an associating instruction, to initiating a matching instruction to perform a friend association based on a key word input by a user and a friend list of the user, according to a preset friend notifying identifying symbol input by the user in a text editing box;
the matching instruction, to determine friends to be selected from the friend list of the user according to the keyword; and
a notifying instruction, to determine at least one friend selected by the user from the friends to be selected as at least one target friend, and send a friend notification to the target friend after the user finishes editing a text and posts the text.

19. The apparatus of claim 18, wherein the associating instruction comprises:
a keyword instruction, to check contents of the text editing box, determine a last friend notifying identifying symbol in front of a current cursor, extract text between the friend notifying identifying symbol and the current cursor except the friend notifying identifying symbol and take the text extracted as the keyword; and
an initiating instruction, to initiate the matching instruction to perform the friend association based on the keyword and the friend list.

20. The apparatus of claim 18, wherein the matching instruction comprises:
a friend to be selected instruction, to determine a friend as the friend to be selected when a name of the friend comprises the keyword; and
a display instruction, to display the friends to be selected as a list at a current cursor position.

21. The apparatus of claim 18, wherein the notifying instruction comprising:
a label instruction, to configure a label indicating a friend for the friend selected by the user from the list of the friends to be selected, and the label comprising contact information of the friend;
a determining instruction, to determine the friend having the label as the target friend; and
a notifying instruction, to send the friend notification to the friend having the label according to the contact information in the label.

22. An apparatus for notifying a friend, comprising:
a processor for executing instructions stored in a memory, the instructions comprise:
a selector instruction, to add a start button in a text editing interface for initiate selection of a target friend; pop up a friend selector when a user presses the start button; the friend selector comprising all friends of the user;
an inserting instruction, to insert a name of a friend selected by the user from the friend selector into a text editing box; and
a notifying instruction, to take at least one friend selected by the user from the friend selector as at least one target friend; and send a friend notification to the at least one target friend after the user finishes editing a text and posts the text.
